(19) United States
(12) Patent Application Publication
(10) Pub. No.: US 2025/0091798 A1
(43) Pub. Date: Mar. 20, 2025

(54) CONFECTIONARY CONTAINER APPARATUS

(71) Applicant: Elissa Stewart, Pomona, MO (US)

(72) Inventor: Elissa Stewart, Pomona, MO (US)

(21) Appl. No.: 18/370,124

(22) Filed: Sep. 19, 2023

(51) Int. Cl. B65D 85/60; A23G 3/56; B65D 25/10

(52) U.S. Cl. CPC B65D 85/60; B65D 25/10; A23G 3/563

(57) ABSTRACT

A confectionary container apparatus for covering a candy of a lollipop includes a housing with a first member and a second member which are pivotally interconnected and define a clamshell arrangement. The first member defines a first cavity and has a first rim defining a first opening to the first cavity. The second member defines a second cavity and has a second rim defining a second opening to the second cavity. The housing is positionable in a closed configuration wherein the first rim lies adjacent to the second rim. A securement member is coupled to the housing and is configured to secure a stick of the lollipop to the housing such that the candy of the lollipop is received into and remains spaced away from the housing.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) FIELD OF THE INVENTION

The disclosure relates to candy containers and more particularly pertains to a new candy container for covering a candy of a lollipop.

### (2) DESCRIPTION OF RELATED ART INCLUDING INFORMATION DISCLOSED UNDER 37 CFR 1.97 AND 1.98

The prior art discloses several containers for covering a candy of a lollipop. However, the prior art fails to describe such a container which clamps to a stick of the lollipop such that the candy of the lollipop does not contact the housing. Such a container would be advantageous over the prior art because germs, saliva, and other foreign matter would be inhibited from transferring to the housing from the candy when using the container.

### (h) BRIEF SUMMARY OF THE INVENTION

An embodiment of the disclosure meets the needs presented above by generally comprising a housing with a first member and a second member which are pivotally interconnected and define a clamshell arrangement. The first member defines a first cavity and has a first rim defining a first opening to the first cavity. The second member defines a second cavity and has a second rim defining a second opening to the second cavity. The housing is positionable in a closed configuration wherein the first rim lies adjacent to the second rim. A securement member is coupled to the housing and is configured to secure a stick of a lollipop to the housing such that a candy of the lollipop is received into and remains spaced away from the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded in-use view of a confectionary container apparatus according to an embodiment of the disclosure with a housing being positioned in an open configuration.

FIG. 2 is a perspective in-use view of an embodiment of the disclosure with a housing being positioned in an open configuration.

FIG. 3 is a front in-use view of an embodiment of the disclosure with a housing being positioned in an open configuration.

FIG. 4 is a cross-section in-use view of an embodiment of the disclosure taken from Arrows 4-4 in FIG. 3.

FIG. 5 is a front in-use view of an embodiment of the disclosure with a housing being positioned in a closed configuration.

FIG. 6 is a cross-section in-use view of an embodiment of the disclosure taken from Arrows 6-6 in FIG. 5.

FIG. 7 is a bottom in-use view of an embodiment of the disclosure with a housing being partially open.

FIG. 8 is a bottom in-use view of an embodiment of the disclosure with a housing being positioned in a closed configuration.

### (j) DETAILED DESCRIPTION OF THE INVENTION

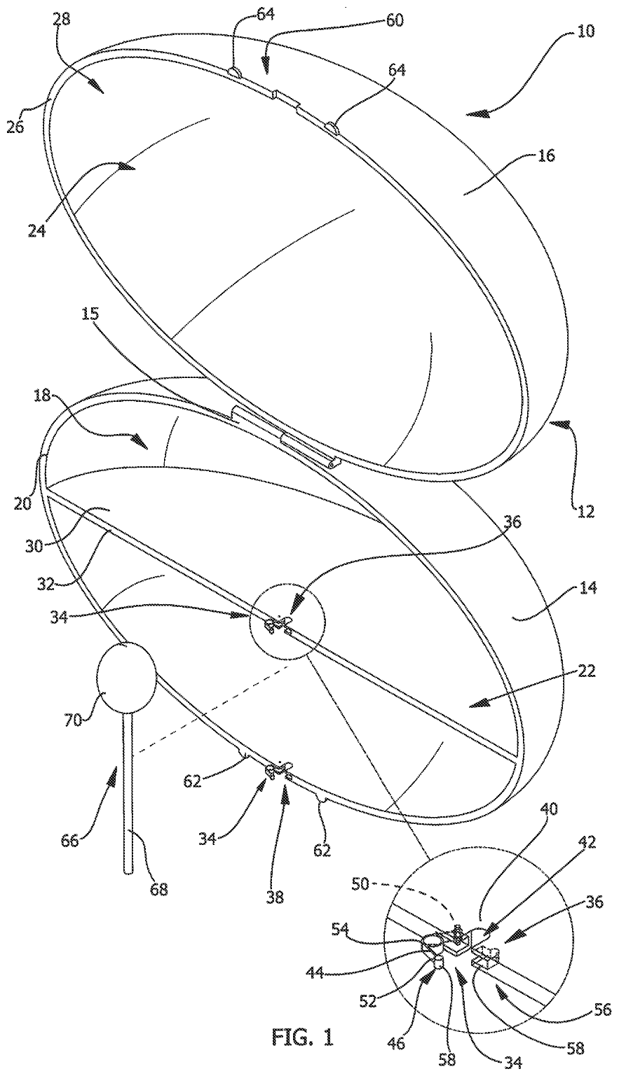

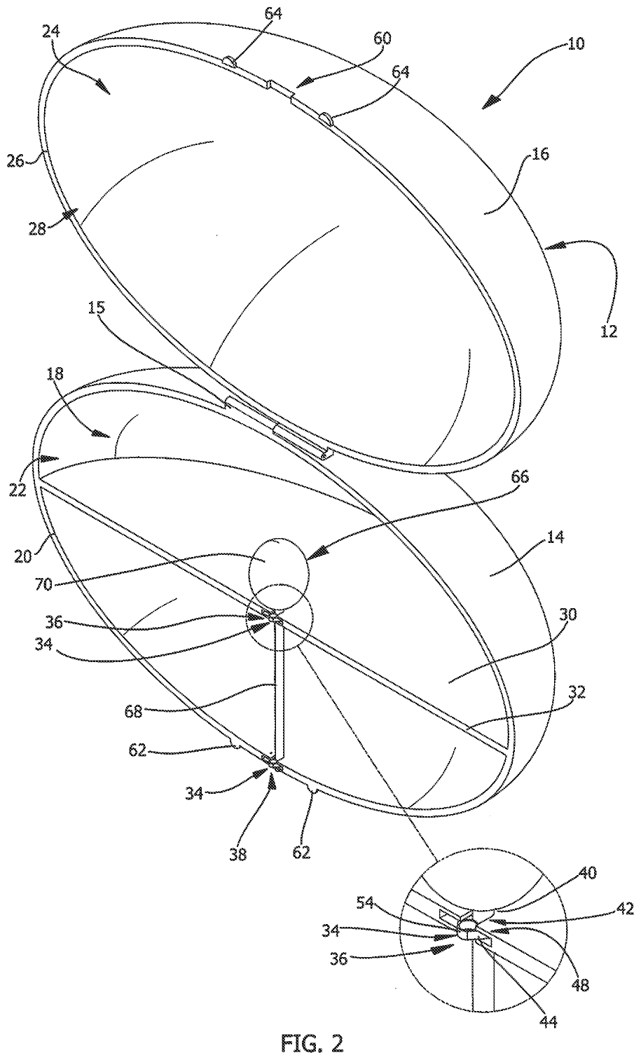

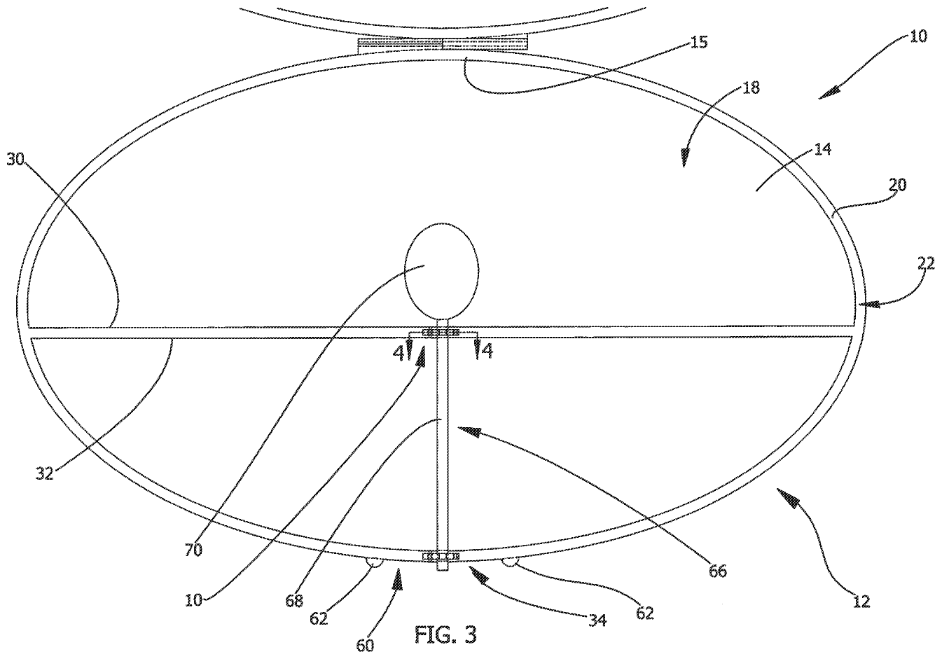

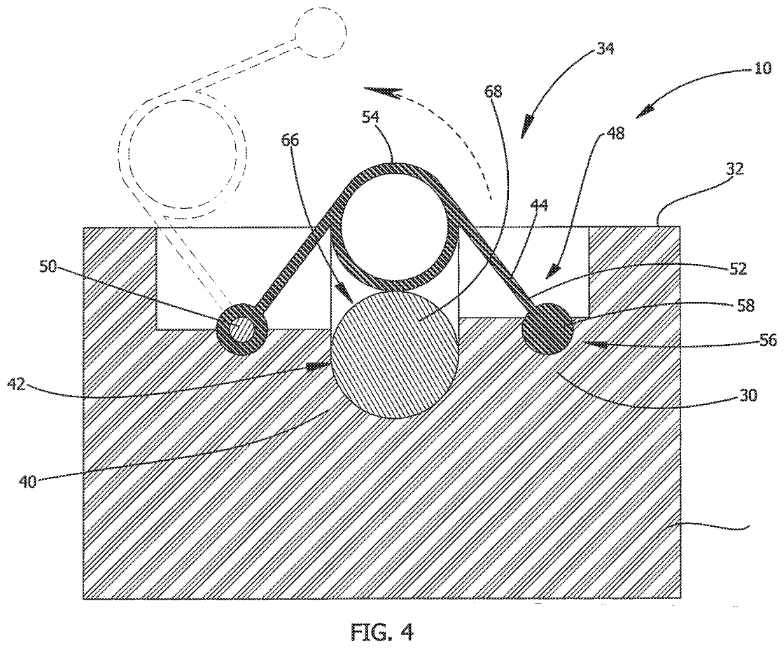

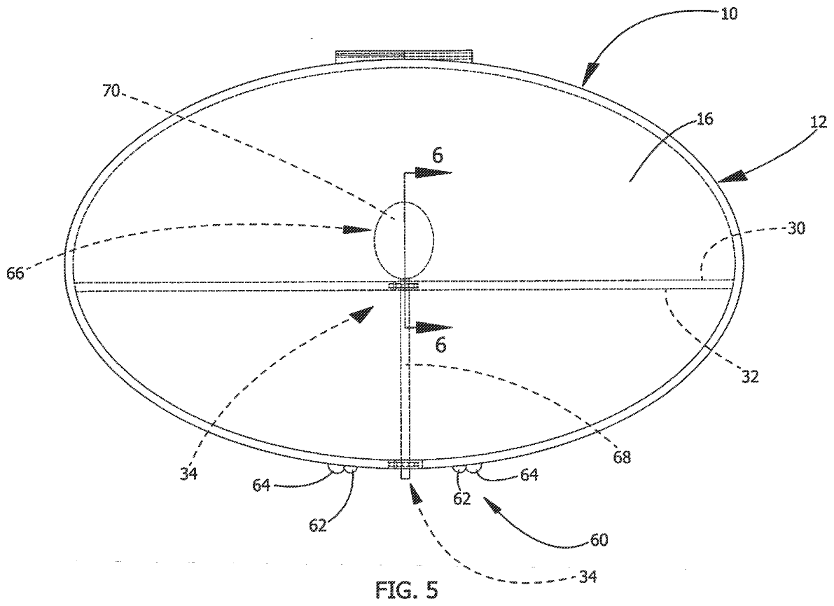

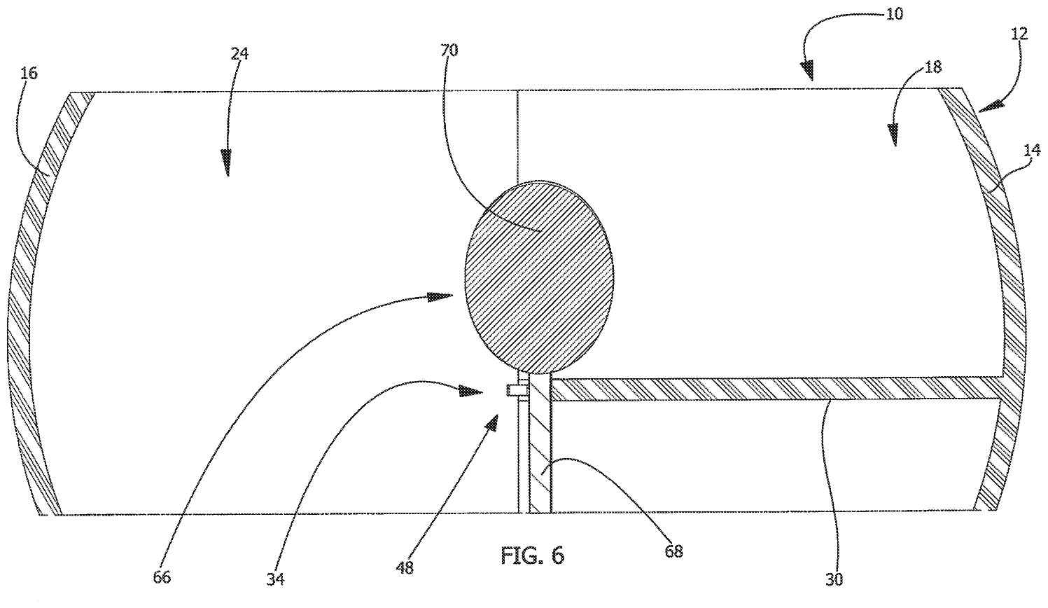

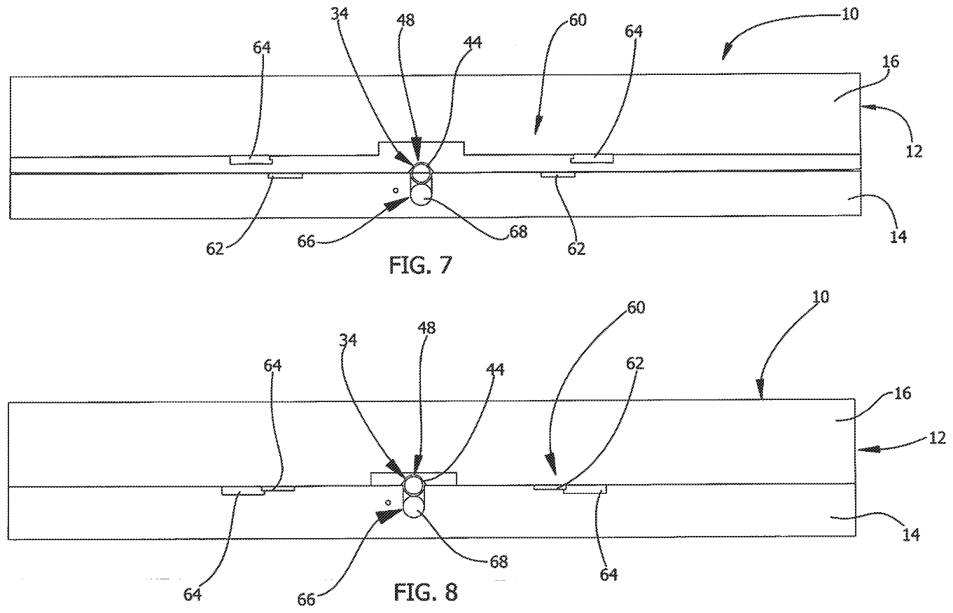

With reference now to the drawings, and in particular to FIGS. 1 through 8 thereof, a new candy container embodying the principles and concepts of an embodiment of the disclosure and generally designated by the reference numeral 10 will be described.

As best illustrated in FIGS. 1 through 8, the confectionary container apparatus 10 generally comprises a housing 12 with a first member 14 and a second member 16 which are pivotally interconnected and define a clamshell arrangement. The first member 14 defines a first cavity 18 and has a first rim 20 defining a first opening 22 to the first cavity 18. The second member 16 defines a second cavity 24 and has a second rim 26 defining a second opening 28 to the second cavity 24. The housing 12 is positionable in a closed configuration 33 wherein the first rim 20 lies adjacent to the second rim 26. The housing 12 further comprises a divider wall 30 mounted in the first member 14, and a free edge 32 of the divider wall 30 is coplanar with the first rim 20. The housing 12 has an ellipsoidal shape when the housing 12 is positioned in the closed configuration 33.

A pair of securement members 34 is coupled to the housing 12. The pair of securement members 34 includes a divider securement member 36 positioned on the free edge 32 of the divider wall 30 and a rim securement member 38 positioned on the first rim 20 of the first member 14 opposite a hinged end 15 of the first member 14. Each securement member 34 of the pair of securement members 34 comprises a receiver 40, a clip 44, and a connector 56. The receiver 40 defines a notch 42, which has a size such that the receiver 40 is configured for receiving a stick 68 of a lollipop 66. The clip 44 is coupled to the receiver 40 and is movable between an open position 46 and a closed position 48 with respect to the notch 42. A first end 50 of the clip 44 is pivotally coupled to the receiver 40, and a second end 52 of the clip 44 is releasably couplable to the housing 12 to secure the clip 44 in the closed position 48. The clip 44 is configured to clamp onto the stick 68 of the lollipop 66 to secure the stick 68 in the receiver 40. The connector 56 is coupled to the clip 44 and the housing 12 to releasably couple the second end 52 of the clip 44 to the housing 12. The connector 56 comprises a pair of mating members 58 which are couplable to each other via a snap fit. A medial section 54 of the clip 44 protrudes away from the receiver 40 when the clip 44 is in the closed position 48.

A fastener 60 is mounted to the housing 12 to secure the housing 12 in the closed configuration 33. The fastener 60 comprises a pair of first tabs 62 and a pair of second tabs 64. The pair of first tabs 62 is coupled to the first member 14 adjacent to the first rim 20, and the pair of second tabs 64 is coupled to the second member 16 adjacent to the second rim 26. Each first tab 62 of the pair of first tabs 62 is releasably couplable to an associated second tab 64 of the pair of second tabs 64 via a snap fit. The fastener 60 also may comprise a latch, a hook-and-loop fastener, a magnet, or the like.

In use, the stick 68 of the lollipop 66 is positionable in the notches 42 of the securement members 34, and the clips 44 of the securement members 34 are positionable in the closed positions 48 to secure the stick 68 in the receivers 40. When the stick 68 of the lollipop 66 is clamped, the securement members 34 hold onto the lollipop 66 so that a candy 70 of the lollipop 66 is received in and spaced away from the housing 12. By retaining the candy 70 away from the housing 12, germs, saliva, and other foreign matter is limited from transferring from the candy 70 to the housing 12. The housing 12 may have a size such that the stick 68 of the lollipop 66 extends out of the housing 12 when the housing 12 is positioned in the closed configuration 33. The medial sections 54 of the clips 44 of the securement members 34 may be urged via a finger or other object to open the clips 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A confectionary container apparatus comprising:
a housing comprising a first member and a second member which are pivotally interconnected and define a clamshell arrangement, the first member defining a first cavity, the first member having a first rim defining a first opening to the first cavity, the second member defining a second cavity, the second member having a second rim defining a second opening to the second cavity, the housing being positionable in a closed configuration wherein the first rim lies adjacent to the second rim; and
a securement member being coupled to the housing, the securement member being configured to secure a stick of a lollipop to the housing such that a candy of the lollipop is received into and remains spaced away from the housing.

2. The apparatus of claim 1, wherein the securement member comprises:
a receiver defining a notch, the notch having a size such that the receiver is configured for receiving a stick of a lollipop;
a clip being coupled to the receiver, the clip being movable between an open position and a closed position with respect to the notch, the clip being configured to clamp onto the stick of the lollipop to secure the stick in the receiver; and
a connector being coupled to the clip and the housing to releasably secure the clip in the closed position.

3. The apparatus of claim 2, wherein a first end of the clip is pivotally coupled to the receiver, a second end of the clip being releasably couplable to the housing to secure the clip in the closed position.

4. The apparatus of claim 3, wherein the connector comprises a pair of mating members, the pair of mating members being couplable via a snap fit.

5. The apparatus of claim 3, wherein the clip has a medial section which protrudes away from the receiver when the clip is in the closed position.

6. The apparatus of claim 1, wherein:
the housing further comprising a divider wall mounted in the first member, a free edge of the divider wall being coplanar with the first rim; and
the securement member is one of a pair of securement members coupled to the housing, the pair of securement members including a divider securement member positioned on the free edge of the divider wall and a rim securement member positioned on the first rim of the first member opposite a hinged end of the first member.

7. The apparatus of claim 1, wherein the housing has an ellipsoidal shape when the housing is positioned in the closed configuration.

8. The apparatus of claim 1, further comprising a fastener being mounted to the housing to secure the housing in the closed configuration.

9. The apparatus of claim 8, wherein the fastener comprises a pair of first tabs and a pair of second tabs, the pair of first tabs being coupled to the first member adjacent to the first rim, the pair of second tabs being coupled to the second member adjacent to the second rim, each first tab of the pair of first tabs being releasably couplable to an associated second tab of the pair of second tabs via a snap fit.

10. A confectionary container apparatus comprising:
a housing comprising a first member and a second member which are pivotally interconnected and define a clamshell arrangement, the first member defining a first cavity, the first member having a first rim defining a first opening to the first cavity, the second member defining a second cavity, the second member having a second rim defining a second opening to the second cavity, the housing being positionable in a closed configuration wherein the first rim lies adjacent to the second rim, the housing further comprising a divider wall mounted in the first member, a free edge of the divider wall being coplanar with the first rim, the housing having an ellipsoidal shape when the housing is positioned in the closed configuration;
a pair of securement members being coupled to the housing, the pair of securement members including a divider securement member positioned on the free edge of the divider wall and a rim securement member positioned on the first rim of the first member opposite a hinged end of the first member, each securement member of the pair of securement members comprising:
a receiver defining a notch, the notch having a size such that the receiver is configured for receiving a stick of a lollipop;
a clip being coupled to the receiver, the clip being movable between an open position and a closed position with respect to the notch, a first end of the clip being pivotally coupled to the receiver, a second end of the clip being releasably couplable to the housing to secure the clip in the closed position, the clip being configured to clamp onto the stick of the lollipop to secure the stick in the receiver, the clip having a medial section which protrudes away from the receiver when the clip is in the closed position; and
a connector being coupled to the clip and the housing to releasably couple the second end of the clip to the housing, the connector comprising a pair of mating members, the pair of mating members being couplable via a snap fit; and
a fastener being mounted to the housing to secure the housing in the closed configuration, the fastener comprising a pair of first tabs and a pair of second tabs, the pair of first tabs being coupled to the first member adjacent to the first rim, the pair of second tabs being coupled to the second member adjacent to the second rim, each first tab of the pair of first tabs being releasably couplable to an associated second tab of the pair of second tabs via a snap fit.
